(19) United States
(12) Patent Application Publication
(10) Pub. No.: US 2003/0154331 A1
(43) Pub. Date: Aug. 14, 2003

(54) System and method for shared use of common GPIO line

(75) Inventors: James E. Bader, Apex, NC (US); Don R. Crafton JR., Raleigh, NC (US); Bankim M. Wani, Raleigh, NC (US)

Correspondence Address: HUNTON & WILLIAMS, INTELLECTUAL PROPERTY DEPARTMENT, 1900 K STREET, N.W., SUITE 1200, WASHINGTON, DC, 20006-1109, US

(73) Assignee: GlobespanVirata Incorporated, Red Bank, NJ

(21) Appl. No.: 09/683,780

(22) Filed: Feb. 13, 2002

(51) Int. Cl. G06F 3/00

(52) U.S. Cl. 710/12

(57) ABSTRACT

Disclosed herein are a method and system for sharing a single GPIO line of an integrated circuit (IC) between at least two circuit components connected concurrently, wherein at least one of the circuit components is to provide input via the GPIO line and at least one circuit component is to receive output via the GPIO line. The input and output can be provided at separate times with the status of the GPIO line changing accordingly or, provided that the input is provided at a lower frequency relative to the switching frequency of the GPIO line, an input to the IC can be provided concurrent with an output from the IC since the low frequency input typically persists until an input cycle of the GPIO line. The present invention finds particular benefit when implemented to interface with GPIO lines of a microprocessor.

### BACKGROUND OF THE INVENTION

The present invention relates generally to the use of general purpose input/output to interface with an integrated circuit, and more particularly to using a single general purpose input/output line to interface with two concurrently connected circuit components.

Microprocessors, microcontrollers, and other integrated circuits (ICs) often make use of general purpose input/output (GPIO) lines to interface with a variety of external circuit components, such as light emitting diodes (LEDs), switches, pushbuttons, other ICs, and the like. These GPIO lines provide for design flexibility as their function as either an input or an output can be configured by a designer, operator, or by internal operation, such as by using a data direction register to set the corresponding one or more GPIO lines as input or output lines. For example, a LED could be connected to a first GPIO line and a switch could be connected to a second GPIO line. In this case, the first GPIO line could be set as an output line to provide a voltage to the LED, resulting in an output of light from the LED, and the second GPIO line could be set as an input line to detect input resulting from an operator engaging the switch.

Due to their obvious utility, circuit developers often prefer to use GPIO lines to interface with external circuit components. However, the number of GPIO lines for a given IC often is insufficient to satisfy all desired connections. Accordingly, developers have developed solutions to provide additional interfaces between the integrated circuit and external circuit components. Referring to FIG. 1, one such solution is illustrated. As illustrated, circuit components 111-114 each are connected to a respective GPIO line 101-104. However, in this example, two additional circuit components 115, 116 are to interface with the IC 110. Since the number of circuit components 111-116 exceeds the number of available GPIO lines 101-104, known solutions implement additional hardware to allow circuit components 115, 116 to interface with the IC 110. As illustrated in FIG. 1, a common hardware solution is to include a control register 120 connected to the IC 110 via a bus 130 and bus pins 105-108, and then to connect the circuit components 115, 116 to the control register 120. When the IC 110 is to provide an output to circuit component 115, the IC 110 can write a value to an address of the control register 120 via the bus pins 105-108 and the bus 130, and this value then is output to the circuit component 115. Similarly, when the circuit component 116 is to input data to the IC 110, the circuit component 116 can write a value to the control register 120 via the bus pins 105-108, and the IC 110 then can poll the associated address of the control register 120 and retrieve the stored value.

While this conventional solution may provide additional interface capabilities between an IC and circuit components, it has a number of limitations. For one, the addition of the control register 120 increases the complexity of the system. Likewise, the addition of the control register 120 typically increases the cost of development and manufacture of a system utilizing such a solution, as well as increases the size and power consumption of such as system.

Accordingly, an improved system and/or method for providing additional interfacing capability to a device having one or more GPIO lines would be advantageous.

### SUMMARY OF THE INVENTION

The present invention mitigates or solves the above-identified limitations in known solutions, as well as other unspecified deficiencies in known solutions. A number of advantages associated with the present invention are readily evident to those skilled in the art, economy of design and resources, greater circuit flexibility, cost savings, manufacturing efficiencies, lessened space requirements, etc. One particular objective of the invention is to enable a single GPIO signal to be shared by one device as an input and another device as an output with the assumption that the two devices do not need to occupy the shared GPIO line simultaneously. However, this is not a strict limitation on the design, for instance, two incoming signals could be shared on a common GPIO line, provided software or hardware is provided to interpret the combined signal and to detect out or to separate the information carried on the combined signal to recognize the respective inputs of the connected devices. The particular arrangements described herein are exemplary only, as other arrangements for capitalizing on the invention will be apparent to those skilled in the art.

The present invention may be applied in a wide variety of electrical circuit applications and is not limited by the exemplary application referred to herein. One exemplary application is the use of the invention in communications modem applications, such as in xDSL modems and other customer premises equipment (CPE), and affiliated hardware, such as central office (CO) equipment. More generally, any applications wherein a limited number input/output lines are available or the economies of decreasing the number of input/output lines is desired will appreciate the present invention.

In accordance with one embodiment of the present invention, a method for sharing a general purpose input/output (GPIO) line of an integrated circuit between at least two circuit components is provided. The method includes providing, using the GPIO line, a first input from a first circuit component to the integrated circuit during a first time and providing, using the same GPIO line, a first output from the integrated circuit to a second circuit component during a second time. The method further provides for the first external circuit component and the second external circuit component to be concurrently coupled to the GPIO line.

In accordance with another embodiment of the present invention, a method for sharing a general purpose input/output (GPIO) line of an integrated circuit is provided. The method includes connecting a first circuit component to the GPIO line, connecting a second circuit component to the same GPIO line concurrently with the first circuit component, wherein the first circuit component is to provide input to the integrated circuit using the GPIO line during a first time, and wherein the second circuit component is to receive an output from the integrated circuit using the same GPIO line during a second time.

In accordance with another embodiment of the present invention, an electrical circuit having circuit components in electrical communication with an integrated circuit is provided, the circuit being adapted to share a general purpose input/output (GPIO) line of the integrated circuit among at least two circuit components. The circuit comprises a first circuit component connected to the GPIO line and a second circuit component connected to the GPIO line concurrently with the first circuit component. The integrated circuit is adapted to receive an input from the first circuit component via the GPIO line during a first time and to provide an output to the second circuit component via the GPIO line during a second time.

In accordance with yet another embodiment of the present invention, a system having a shared GPIO line is provided, the system including an integrated circuit having a general purpose input/output (GPIO) line, a first external circuit component coupled to the GPIO line, wherein the first external circuit component is adapted to provide, at a first time, a first input to the integrated circuit using the GPIO line, and a second external circuit component coupled to the GPIO line, wherein the second external circuit component is adapted to receive, at a second time, a first output from the integrated circuit using the GPIO line.

Still further features and advantages of the present invention are identified in the ensuing description, with reference to the drawings identified below.

### BRIEF DESCRIPTION OF THE DRAWINGS

The purpose and advantages of the present invention will be apparent to those of ordinary skill in the art from the following detailed description in conjunction with the appended drawings in which like reference characters are used to indicate like elements, and in which:

FIG. 1 is a block diagram illustrating a prior-art solution for interfacing a number of external circuit components in excess of a number of GPIO lines;

FIG. 2 is a block diagram illustrating a system for sharing a single GPIO line between two circuit components in accordance with at least one embodiment of the present invention;

FIGS. 3 and 4 are block diagrams illustrating a method for receiving input from one circuit component and providing an output to another circuit component at separate times using a common GPIO line in accordance with at least one embodiment of the present invention;

FIG. 5 is a block diagram illustrating an exemplary implementation of two circuit components sharing a single GPIO line in accordance with at least one embodiment of the present invention; and

FIG. 6 is a chart illustrating an exemplary operation of two circuit components sharing a single GPIO line in accordance with at least one embodiment of the present invention.

### DETAILED DESCRIPTION OF THE INVENTION

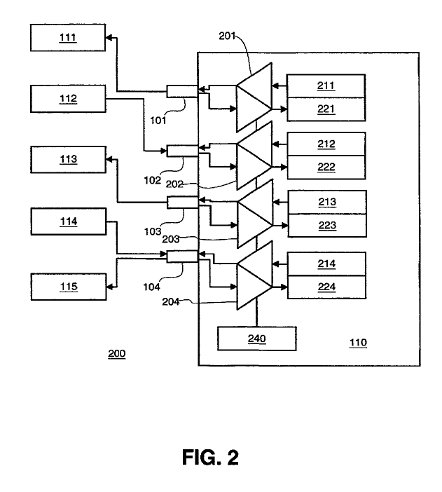

FIGS. 2-5 illustrate a method and a system for sharing a single GPIO line of an integrated circuit (IC) between two circuit components connected concurrently, one of the circuit components to provide an input via the GPIO line and the other circuit component is to receive an output via the same GPIO line, where either the input and the output occur at essentially separate times thereby eliminating any potential interference, or the input is provided at a relatively low frequency relative to the switching frequency of the GPIO so that the input persists until an input cycle of the GPIO line. One advantage of one embodiment of the present invention is a reduced complexity compared to known solutions. Another advantage is that the cost of implementation is reduced. Yet another advantage is that power consumption is minimized.

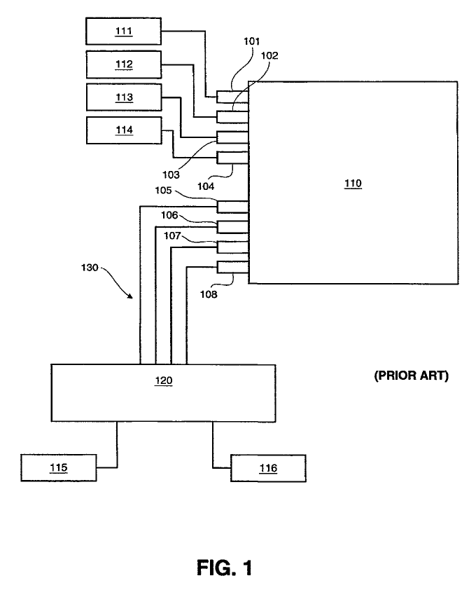

Referring now to FIG. 2, a system for sharing a single GPIO line is illustrated in accordance with at least one embodiment of the present invention. The system 200 includes five external circuit components 111-115, herein referred to as circuit components, and an integrated circuit (IC) 110 having four GPIO lines 101-104. The number of GPIO lines and circuit components illustrated in FIG. 1 are exemplary and intended for explanatory purposes only. The IC 110 can include any of a variety of ICs, such as a microprocessor, a microcontroller, an application specific integrated circuit (ASIC), a field programmable gate array (FPGA), a programmable logic device (PLD), programmable array logic (PAL), and the like. The circuit components can include any electrical components or circuit components external to the IC 110 that are adapted to receive an input from an IC, such as a servo motor, a light emitting diode (LED), another IC, and the like, or to provide an input to an IC, such as a switch, a light sensor, a motion sensor, another IC, and the like.

In the illustrated embodiment, each GPIO line 101-104 is connected to a respective I/O assembly 201-204, which in turn is connected to an output buffer 211214 and an input buffer 221-224. The I/O assemblies 201-204 include an input tristate buffer and an output tristate buffer, where a GPIO direction register 240 controls the direction of data flow through each of the I/O assemblies 201-204 individually. In this embodiment, when data is to be output by the IC 110 via a GPIO line (GPIO line 101, for example), the IC 110 writes the data to the output buffer 211 and configures the GPIO direction register 240 to set the I/O assembly 201 to allow the data stored in the output buffer 211 to be output to the circuit component 111. Likewise, if it is desired to receive input via a GPIO line, such as via GPIO line 102, the IC 110 configures the GPIO direction register 240 to set the I/O assembly 202 to allow data to be input and stored in the input buffer 222. This mechanism for implementing GPIO, as well as other mechanisms for GPIO implementation, is well known to those skilled in the art. Although this mechanism has been discussed for illustrative purposes, any mechanism for implementing GPIO may be utilized without departing from the spirit or the scope of the present invention.

As illustrated in FIG. 2, the five circuit components 111-115 desired to interface with the IC 110 exceeds the four available GPIO lines 101-104. Known solutions, as discussed previously, typically require additional hardware to connect additional circuit components to the IC 110. However, in the event that there is at least one circuit component of circuit components 111-115 that only provides an input to the IC 110 and at least one circuit component that only receives an output from the IC 110, then these at least two of circuit components 111-115 (one to provide an input and one to receive an output) can share a single GPIO line 101-104 provided that either their input and output occur at essentially separate times or that their operation is not significantly effected by the switching of the GPIO line between an input line and an output line.

In the illustrated embodiment, circuit components 111, 113, adapted to receive outputs from IC 110, are connected to GPIO lines 101, 103, respectively, and the circuit component 112, adapted to provide an input to IC 110, is connected to the GPIO line 102. The circuit component 114, adapted to provide an input to IC 110, and the circuit component 115, adapted to receive an output from IC 110, are concurrently connected to the GPIO line 104. It will be appreciated that circuit components 111-113 may interface with the IC 110 at any time since there is a one-to-one relation between the circuit components 111-113 and the GPIO lines 101-103.

Since circuit components 114, 115 share a single GPIO line 104, the circuit component 114 typically cannot provide an input to the IC 110 at the same time that the circuit component 115 receives an output from the IC 110. However, should the input from the circuit component 114 occur at a low frequency relative to the switching frequency of the GPIO line 104 and input from the circuit component 114 has minimal effect on the output voltage of the GPIO line 104 during an output cycle, then the circuit components 114, 115 can be connected concurrently to the GPIO line 104 without interfering with each other's operation. The term switching frequency, as used herein, refers to the frequency at which the GPIO line 104 cycles between functioning as an input line and functioning as an output line. For example if the GPIO line 104 operates as an output line for 7 processing cycles and an input line for 1 processing cycle, with the sequence repeating, and if each processing cycle is 1 microsecond, the switching frequency of the GPIO line 104, in this case, is 125,000 switch cycles per second, or 125 kHz.

In at least one embodiment, output to circuit component 115 and input from circuit component 114 be attempted concurrently due to a high switching frequency of the shared GPIO line between an input line to an output line. For example, circuit component 114 can include a switch and circuit component 115 can include a LED. In this example, the IC can switch between an input line to receive input caused by activating the switch (circuit component 114) and an output line to provide a voltage to the LED (circuit component 115). If the GPIO line 104 acts as an output line more often than an input line, than the appearance of the LED typically is unaffected, assuming the GPIO line 104 is switched faster than the human flicker-fusion rate. Likewise, because the typical human reaction time is about 0.20 seconds and because the period between two input states of the GPIO line 104 typically is much less than this reaction time, the GPIO line 104 is switched to an input line during the switch activation period, and therefore the input from the switch is noted by the IC 110.

In another embodiment, the circuit components 114, 115 can be connected concurrently to the GPIO line 104 should their input/output occur at essentially separate times. In this case, the IC 110, having knowledge of the timing of the expected input from circuit component 114 and the output to the circuit component 115, can switch the GPIO line 104 from an input line to an output line as appropriate. The timing can be stored as a table in the memory of the IC 110, configured using a state machine, and the like. The term essentially separate is intended to convey that, in at least one embodiment, the input and output from two circuit components over a single GPIO line are not necessarily entirely mutually exclusive in the time domain. Rather, the main component of the inputs and the outputs are mutually exclusive. To illustrate, due to the physical properties of pushbuttons, the activation of a pushbutton often causes a main signal during the activation of the pushbuttons as well as subsequent secondary signal fluctuations, known as contact bounce, after the activation of the pushbutton has been activated. In this case, the secondary signal fluctuations can overlap an output from the IC 110 without being considered to overlap with the output, since the secondary signal fluctuations are not intended to be input.

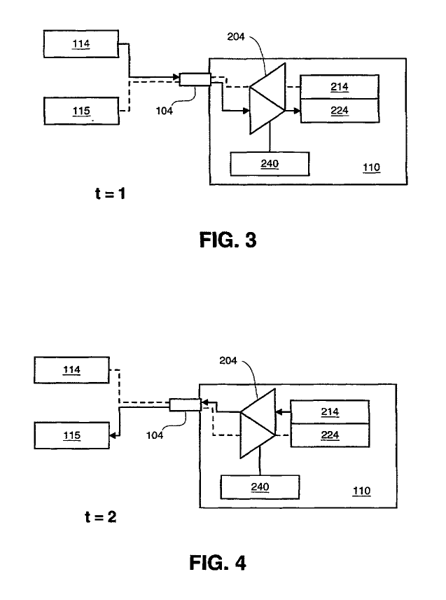

Referring now to FIGS. 3 and 4, a method for sharing a single GPIO line among at least two circuit components is illustrated in accordance with at least one embodiment of the present invention. As discussed previously, the circuit components 114, 115 can be concurrently connected to the GPIO line 104 in the event that the input from the circuit component 114 occurs at a low frequency relative to the switching frequency of the GPIO line 104. Alternatively, the circuit components 114, 115 can be concurrently connected to the GPIO line 104 when the input from circuit component 114 and the output to circuit component 115 are provided at essentially separate times, and the timing of the input/output is known to at least the IC 110.

As illustrated in FIG. 3, during a first time period (time t=1), the IC 110 configures the GPIO direction register 240 to set the I/O direction assembly 204 to allow input on the GPIO line 104. Accordingly, during this first time period the circuit component 114 can provide input, stored in the input buffer 224, to the IC 110 via the GPIO line 104. It will be appreciated that since the input from the circuit component 114 is at a low frequency relative to the switching frequency of the GPIO line, the input from the circuit component persists over at least one switching cycle of the GPIO line 104, thereby allowing the GPIO line 104 to switch between input and output at least one time during an input from the circuit component 114.

As illustrated in FIG. 4, the IC 110 can configure the GPIO direction register 240 to set the I/O direction assembly 204 to allow data or a signal to be output on the GPIO line 104 during a second time period (t=2). The IC 110 can then write data to the output buffer 214 during this second time period, where it is then provided to the circuit component 115 via the GPIO line 104. In this manner, the IC 110 may alternate between receiving and providing data from circuit components 114, 115, respectively, as desired.

As discussed, at least one embodiment of the present invention provides for at least two circuit components to be concurrently connected to a single GPIO line without requiring any additional hardware. Generally, the only modification needed to allow sharing of the GPIO line in accordance with the present invention includes modifying the programming/design of the IC 110 to accommodate switching the GPIO line from an input line to an output line, and vice versa, at the appropriate times. This can be accomplished in a variety of ways. For example, assume that the circuit component 114 is to provide input only during a specified time period, such as during the first millisecond of an operation of the IC 110. In this case, the IC 110 could be configured to set the GPIO line as an input line for the first millisecond of its operation, and when that millisecond has ended, as indicated by a timer or counter, it could then set the GPIO line as an output line for the remainder of the operation. Alternatively, the IC 110 could be configured to set the GPIO line as an input line for a certain number or sequence of processing cycles of a given operation, then switch the GPIO line to an output line for a certain number or sequence of processing cycles, and so on. Although a number of examples of mechanisms for directing the switching of a shared GPIO line have been disclosed, those skilled in the art can develop other mechanisms to direct the switching of shared GPIO lines between input lines and output lines using the guidelines provided herein.

Although FIGS. 3 and 4 illustrate two circuit components sharing a GPIO line, in at least one embodiment, more than two circuit components can be concurrently connected to a common GPIO line. For example, two switch circuits and a LED circuit can be connected concurrently to GPIO line 104. In this case, the two switch circuits could both be reset switches placed in separate locations of a device implementing the IC 110, and by activating either switch, the operation of the IC 110 can be reset when the input from the activated switch or switches is noticed by the IC 110 on the GPIO line 104.

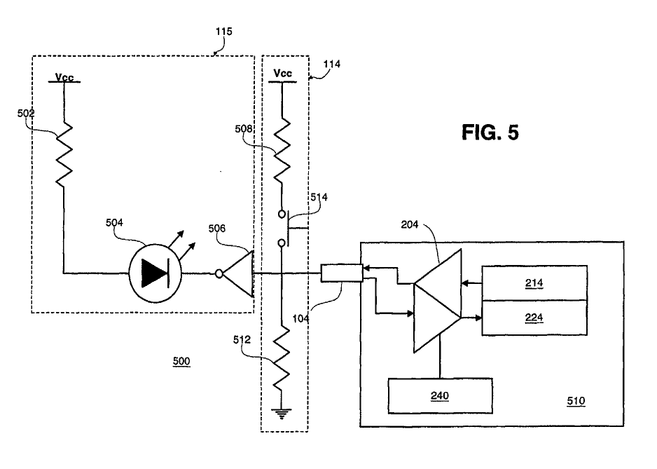

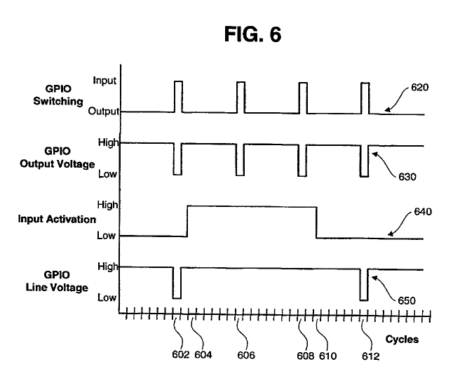

Referring now to FIGS. 5 and 6, an exemplary system 500 having a shared GPIO line 104 of a microprocessor and an exemplary operation of the system 500 are illustrated in accordance with at least one embodiment of the present invention. As illustrated in FIG. 5, the system 500 includes a microprocessor 510 (one embodiment of the IC 110 of FIG. 2) having one or more GPIO lines 104, such as the HELIUM processor available from the Virata Corporation of Santa Clara, Calif. The system 500 further includes two circuit components 114, 115 concurrently connected to the single GPIO line 104.

In the illustrated exemplary embodiment, the circuit component 114 includes a resistor 508 having one lead connected to a voltage, Vcc, and another lead connected to a lead of a pushbutton switch 514. The other lead of the pushbutton switch 514 is connected to the GPIO line 104 and to a lead of a resistor 512, where the other lead of the resistor 512 is connected to ground. The design of the circuit component 114 is intended to allow a user to provide an input to the microprocessor 510 by pressing the pushbutton switch 514, thereby causing a voltage to occur at the GPIO line 104 when the pushbutton switch 514 is closed. This voltage can then be detected and interpreted as input data by the microprocessor 510 during an input period on the GPIO line 104.

The exemplary embodiment of the circuit component 115 includes a resistor 502 having one lead connected to the voltage Vcc and the other lead connected to a LED 504. The other lead of the LED 504 is connected to the output of an inverter 506, and the input of the inverter 506 is connected to the GPIO line 104. The design of the circuit component 115 is adapted to cause the LED 504 to emit light when the microprocessor 510 places a voltage on the GPIO line 104 (i.e., high or logic 1 output on the GPIO line 104).

It will be appreciated that the values the resistor 508 and the resistor 512 can be selected such that an activation of the pushbutton 514 would have no significant effect on the voltage level of the GPIO line 104 while the GPIO line 104 is operating as an output line. As a result, the circuit component 114 can attempt to provide an input to the IC 110 via GPIO line 104 at the same time that the IC 110 is providing an output to the circuit component 115 via GPIO line 104. Since the circuit component 114 has a greater impedance, the activation of the pushbutton 514 generally would have no effect on the voltage level of the GPIO line 104 until the GPIO line 104 was switched to an input line.

The timing of the switch between receiving input from the circuit component 114 and providing output to the circuit component 115 can be implemented in a variety of ways. In one exemplary method, assume that the system 200 is implemented as part of a digital subscriber line (DSL) modem, where microprocessor 510 includes a communications processor, the circuit component 114 includes a reset switch, and the circuit component 115 includes a line activity indicator of a line to which the DSL modem is connected. In this case, the microprocessor 510 can switch the GPIO line 104 between operating as an input line and an output line, such as by configuring the GPIO direction register 240, thereby polling the status of the pushbutton switch 514. For example, the microprocessor could direct, via the GPIO direction register 240, the GPIO line 104 to act as an input line for 5 processing cycles, as an output line for 40 processing cycles, then as an input line for 5 processing cycles, and so on. Because the proportion of input cycles to the number of output cycles is relatively small in this example, a user is unlikely to notice any affect on the operation of the line activity indicator (the LED 504 of the circuit component 115) caused by the high switching frequency. Indeed, additional discrete components, such as a capacitor, could be added to counteract undesired effects. Likewise, if the pushbutton switch 514 is activated to reset the system, the resulting voltage input at GPIO line 104 can be observed during an input cycle by the microprocessor 510 and the system 200 is reset accordingly. As a result, the GPIO line 104 can be shared between a circuit component having an input and a circuit component having an output without noticeably degrading the operation of either even in the event that input is attempted at the same time that output is provided.

An exemplary operation of the system 500 is illustrated in FIG. 6. The GPIO switching graph 620 includes a graph representative of the switching of the GPIO line 104 between an input line to an output line, and vice versa, where the switching cycle of the GPIO line 104 includes 7 cycles as an output line followed by 1 cycle as an input line. The GPIO output voltage graph 630 includes a graph representative of the output voltage provided by the IC 110 to the GPIO line 104. In this example, it is assumed that the output voltage is set to high during each output cycle of the GPIO line 104. The input activation graph 640 includes a graph representative of the activation of the pushbutton 514 by a user. In this example, it is assumed that the pushbutton 514 is activated at cycle 604 and persists through cycle 610. The GPIO line voltage graph 650 includes a graph representative of the actual voltage level on the GPIO line 104 during the operation of the IC 110. It will be appreciated that graphs 630 and 650 differ in that the graph 630 represents the voltage of the GPIO line 104 provided by the IC 110 and is therefore at a low voltage during an input cycle, whereas graph 650 represents the actual voltage on the GPIO line 104 resulting from both activity by the IC 110 during an output cycle and activity from the circuit component 114 during an input cycle. Recall that, in at least one embodiment, circuit components 114, 115 are selected/designed such that an input provided by the circuit component 114 during an output cycle of the GPIO line 104 has little or no effect on the voltage level of the GPIO line 104 provided by the IC 110. The abscissa of charts 620-650 represents a sequence of processing cycles of the IC 110.

As noted previously, the GPIO line 104 can be shared in two instances, one being that the input from circuit 114 and the output to circuit component 115 occur at essentially separate times, and the other instance including a circuit component 114 having a relatively low frequency input compared to the switching frequency of the GPIO line 104. In at least one embodiment, the input of the circuit component 114 is considered to occur at a relatively low frequency when the input from the circuit component 114 persists for a minimum of one switching cycle of the GPIO line 104. To illustrate, input from the circuit component 114 (the activation of the pushbutton 514) could be considered to be of a relatively low frequency if an input persisted at least from cycle 602 to cycle 606. The inputs from many types of input circuit components, such as switches, motion detectors, and light sensors, easily persist for multiple switch cycles of high-speed ICs (microprocessors, for example). For example, as noted previously, switches such as pushbutton 514 often remain activated for about 0.20 seconds due to the reaction time of the average human. On the other hand, a GPIO line typically can be switched at much faster frequency, generally measured in microseconds. By persisting over at least one switch cycle, the input can be observed by the IC 110 even if the input were to be initiated during an output cycle of the GPIO line 104.

As illustrated in FIG. 6, the output voltage of the GPIO output voltage graph 630 is a low voltage during cycles 602, 606, 608, 612. As a result of this cyclic drop in voltage, the LED 504 of circuit component 115 blinks. However, due to the high proportion of output cycles to input cycles of the GPIO line 104 (7:1 in this example) and the relatively short switching cycle (measured in microseconds), this flash is imperceptible to the human eye due to the flicker-fusion phenomenon. Accordingly, the operation of the LED 504 remains, for all intents and purposes, unaffected by the switching of the GPIO line 104 to an input line for a short duration of time. In fact, this blinking can be used to an advantage. For example, when the IC 110 desires an input from a user, the number of input cycles could be considerably increased in comparison to the number of output cycles to cause the blinking of the LED 504 to be visible to the user. This visible blinking can then be used as a cue for the user to press pushbutton 514 to provide input to the IC 110.

Other embodiments, uses, and advantages of the invention will be apparent to those skilled in the art from consideration of the specification and practice of the invention disclosed herein. The specification should be considered exemplary only, and the scope of the invention is accordingly intended to be limited only by the following claims and equivalents thereof.

What is claimed is:

1. A method for sharing a single general purpose input/output (GPIO) line of an integrated circuit between at least two circuit components, the method comprising:
providing, using the GPIO line, a first input from a first circuit component to the integrated circuit during a first time;
providing, using the GPIO line, a first output from the integrated circuit to a second circuit component during a second time; and
wherein the first circuit component and the second circuit component are concurrently coupled to the GPIO line.

2. The method of claim 1, wherein the step of providing the first input includes providing the first input at a low frequency relative to a switching frequency of the GPIO line.

3. The method of claim 2, wherein the first time is at least in part concurrent with the second time.

4. The method of claim 1, wherein the first time is different from the second time.

5. The method of claim 1, further comprising the step of providing, using the GPIO line, a second input from the first circuit component to the integrated circuit during a third time different from the first time.

6. The method of claim 1, further comprising the step of providing, using the GPIO line, a second output from the integrated circuit to the second circuit component during a third time different from the second time.

7. The method of claim 1, wherein the step of providing a first input comprises the step of configuring the GPIO line as an input line during a portion of the first time, and the step of providing a first output comprises the step of configuring the GPIO line as an output line during the second time.

8. The method of claim 7, wherein:
the portion includes a first sequence of processing cycles; and
the second time includes a second sequence of processing cycles different from the first sequence.

9. The method of claim 1, wherein the first circuit component includes a switch.

10. The method of claim 1, wherein the second circuit component includes a light emitting diode.

11. The method of claim 10, wherein the second circuit component further includes an inverter.

12. The method of claim 1, wherein the integrated circuit comprises one or more of a group consisting of: a microprocessor, a microcontroller, a field programmable gate array, a programmable logic device, a programmable logic array, and an application specific integrated circuit.

13. A method for sharing a general purpose input/output (GPIO) line of an integrated circuit, the method comprising:
connecting a first circuit component to the GPIO line;
connecting a second circuit component to the GPIO line concurrently with the first circuit component;
wherein the first circuit component is to provide input to the integrated circuit using the GPIO line during a first time; and
wherein the second circuit component is to receive an output from the integrated circuit using the GPIO line during a second time.

14. The method of claim 13, wherein the step of providing the first input includes providing the first input at a low frequency relative to a switching frequency of the GPIO line.

15. The method of claim 14, wherein the first time is at least in part concurrent with the second time.

16. The method of claim 13, wherein the first time is different from the second time.

17. The method of claim 13, further comprising the steps of:
configuring the GPIO line as an input line during a portion of the first time; and
configuring the GPIO line as an output line during the second time period.

18. The method of claim 17, wherein:
the portion includes a first sequence of processing cycles; and
the second time includes a second sequence of processing cycles different from the first sequence.

19. The method of claim 13, wherein the first circuit component includes a switch.

20. The method of claim 13, wherein the second circuit component includes a light emitting diode.

21. The method of claim 20, wherein the second circuit component further includes an inverter.

22. The method of claim 13, wherein the integrated circuit is one of a group consisting of: a microprocessor, a microcontroller, a field programmable gate array, a programmable logic device, a programmable logic array, and an application specific integrated circuit.

23. An electrical circuit having circuit components in electrical communication with an integrated circuit, the circuit being adapted to share a general purpose input/output (GPIO) line of the integrated circuit among at least two circuit components external to the integrated circuit, the circuit comprising: a first circuit component connected to the GPIO line; a second circuit component connected to the GPIO line concurrently with the first circuit component; the integrated circuit being adapted to receive an input from the first circuit component via the GPIO line during a first time; and the integrated circuit being adapted to provide an output to the second circuit component via the GPIO line during a second time.

24. The circuit of claim 23, wherein the first circuit is adapted to provide the first input at a low frequency relative to a switching frequency of the GPIO line.

25. The circuit of claim 24, wherein the first time is at least in part concurrent with the second time.

26. The circuit of claim 23, wherein the first time is different from the second time.

27. The circuit of claim 23, wherein the GPIO line is configured as an input line during a portion of the first time, and the GPIO line is configured as an output line during the second time.

28. The circuit of claim 27, wherein the portion includes a first sequence of processing cycles, and the second time includes a second sequence of processing cycles different from the first sequence.

29. The circuit of claim 23, wherein the first circuit component includes a switch.

30. The circuit of claim 23, wherein the second circuit component includes a light emitting diode.

31. The circuit of claim 30, wherein the second circuit component further includes an inverter.

32. The circuit of claim 23, wherein the integrated circuit comprises at least one of a group consisting of: a microprocessor, a microcontroller, a field programmable gate array, a programmable logic device, a programmable logic array, and an application specific integrated circuit.

33. In a system comprising electrical circuitry and components:
an integrated circuit having a general purpose input/output (GPIO) line;
a first circuit component coupled to the GPIO line, wherein the first circuit component is adapted to provide, at a first time, a first input to the integrated circuit using the GPIO line; and
a second circuit component coupled to the GPIO line, wherein the second circuit component is adapted to receive, at a second time, a first output from the integrated circuit using the GPIO line.

34. The system of claim 33, wherein the first circuit component further is adapted to provide the first input at a low frequency relative to a switching frequency of the GPIO line.

35. The system of claim 34, wherein the first time is concurrent with the second time.

36. The system of claim 33, wherein the first time is different from the second time.

37. The system of claim 36, wherein:
the first time includes a first sequence of processing cycles; and
the second time includes a second sequence of processing cycles different from the first sequence.

38. The system of claim 33, wherein the integrated circuit comprises at least one of a group consisting of: a microprocessor, a microcontroller, a field programmable gate array, a programmable logic device, a programmable logic array, and an application specific integrated circuit.

39. The system of claim 33, wherein the first circuit component includes a switch.

40. The system of claim 33, wherein the second circuit component includes a light emitting diode.

41. The system of claim 40, wherein the second circuit component further includes an inverter.

42. The system of claim 33, wherein the system comprises a communications modem.

43. The system of claim 42, wherein the communications modem includes the first and second circuit components.

44. The system of claim 43, wherein the system is a DSL communications system.
